(19) United States
(12) Patent Application Publication
(10) Pub. No.: US 2010/0182128 A1
(43) Pub. Date: Jul. 22, 2010

(54) TAG IDENTIFICATION METHOD, TAG ANTICOLLISION METHOD, RFID TAG

(75) Inventors: Sung Kwon Kim, Seoul (KR); Jae-Dong Shin, Seoul (KR); Jung Sik Cho, Seoul (KR)

Correspondence Address: OCCHIUTI ROHLICEK & TSAO, LLP, 10 FAWCETT STREET, CAMBRIDGE, MA, 02138, US

(73) Assignee: Chung-Ang University Industry-Academic Cooperation Foundation, Seoul (KR)

(21) Appl. No.: 12/443,207

(22) PCT Filed: Oct. 16, 2008
(86) PCT No.: PCT/KR08/06094

§ 371 Date: Mar. 27, 2009

(30) Foreign Application Priority Data
Jan. 4, 2008 (KR) 10-2008-0001198

(51) Int. Cl. H04Q 5/22

(52) U.S. Cl. 340/10.2; 340/10.4

(57) ABSTRACT

Provided is a tag identification method in an RFID system. A tag identification method generates a query tree according to a query and a response between an RFID reader and a tag to identify the tag. In the method, a query message is transmitted from the RFID reader to the tag. A response message for the query message is received from the tag. Herein, the query tree is generated in the reverse order of a string owned by the tag. The query tree is generated in the reverse order of the tag IDs in the query tree-based protocol to reduce the frequency of collisions between the tags, thereby making it possible to reduce the time taken to identify all the tags within the recognizable range of the RFID reader.

### TECHNICAL FIELD

The present invention relates to a Radio Frequency IDentification (RFID) tag, and more particularly, to a method of identifying a tag by preventing a collision between tags and an RFID tag using the same.

### BACKGROUND ART

A Radio Frequency IDentification (RFID) technology is a non-contact radio identification technology. In the RFID technology, necessary information is stored in a tag including an Integrated Circuit (IC) chip and an antenna for radio communication; and an RFID reader capable of collect information of the tag communicates with the tag through an RF band.

The RFID technology has various advantages over a barcode technology.

First, because the tag, unlike the barcode, need not be printed on the surface, it is not troubled by contamination. Second, the RFID technology uses radio communication, thus making it unnecessary to approach tags to an RFID reader one by one. Third, the RFID technology provides a multiple identification technology, thus making it possible to identify a plurality of tag data within a short time. Fourth, the RFID technology can input a large amount of information into a tag, unlike the barcode technology that prints a simple ID code on the surface. Fifth, while the barcode technology uses the same ID code for the same type of products, the RFID technology can use a unique ID code for each product, thus making it possible to provide accurate and rapid managements in terms of product sale and stock management.

An RFID reader must identify information about many tags in radio communication environments, but in this process there may be a collision between the tags. A tag must report information corresponding to a query received from the RFID tag, but the tag does not have a function of detecting the current use status of a radio channel. Also, because a plurality of tags share a radio channel with each other, one or more tags may simultaneously transmit data to the RFID reader. If data are simultaneously transmitted from a plurality of tags through the same channel, the RFID reader cannot identify the tag information. This is called a collision between tags in the RFID system, and a protocol between the RFID reader and the tag for prevention of the collision is called an anti-collision protocol.

The anti-collision protocols can be broadly classified into an ALOHA-based protocol and a tree-based protocol. The ALOHA-based protocol divides time on a slot basis and allows only one tag to randomly respond in one time slot, so that an RFID reader identifies a tag. Because the ALOHA-based protocol is based on uncertainty of randomness, an RFID reader may fail to identify all tags and it is difficult to predict the time taken to identify all the tags.

The tree-based protocol uses unique IDs of tags to generate a tree while performing a tag identification process. An RFID reader using the tree-based protocol can identify all tags and can predict the process. However, if there are many tags with similar IDs in the tree-based protocol, a collision may occur during generation of a tree. In this case, the tree is deepened and thus a long time is taken to identify the tag.

### DISCLOSURE

### Technical Problem

The present invention provides a tag identification method and a tag anti-collision method, which can reduce a tag identification time in a Radio Frequency IDentification (RFID) system, and an RFID tag using the same.

### Technical Solution

According to an aspect of the present invention, a tag identification method for generating a query tree according to a query and a response between an RFID reader and a tag to identify the tag includes: transmitting a query message from the RFID reader to the tag; and receiving a response message for the query message from the tag, wherein the query tree is generated in the reverse order of a string owned by the tag. The query message may be a suffix of the string. If there is a collision between the response message and a response message from another tag, the RFID reader may generate a string, which is obtained by attaching an additional character to the suffix, in a queue. The tag may compare the query message with the string in the order of from the least significant bit to the most significant bit of the string to transmit the response message. The tag may generate a reversed ID for the ID of the tag to make a comparison with the query message. According to another aspect of the present invention, a tag anti-collision method includes: receiving a first suffix from an RFID reader; transmitting a first response message after comparison of the first suffix with a tag ID in reverse order; receiving a second suffix longer than the first suffix after transmission of the first response message; and transmitting a second response message after comparison of the second suffix with the tag ID in reverse order. The first suffix may be a string of the least significant bit (LSB) to the m^{th} bit of the tag ID; the second suffix may be a string of the least significant bit (LSB) to the n^{th} bit of the tag ID; ‘n’ may be greater than ‘m’; and ‘n’ and ‘m’ may be integers greater than 0.

According to another aspect of the present invention, an RFID tag includes: a demodulator unit receiving a query message from an RFID reader to demodulate the query message; a controller unit comparing a string contained in the query message with a tag ID in reverse order and generating a response message if the string is equal to the tag ID; and a modulator unit modulating the response message prior to transmission. The response message may be the tag ID.

### ADVANTAGEOUS EFFECTS

As described above, the present invention generates the query tree in the reverse order of the tag IDs in the query tree-based protocol to reduce the frequency of collisions between the tags, thereby making it possible to reduce the time taken to identify all the tags within the recognizable range of the RFID reader.

### DESCRIPTION OF DRAWINGS

FIG. 1 is a block diagram of an example of a Radio Frequency IDentification (RFID) system.

FIG. 2 is a block diagram of an example of an RFID reader.

FIG. 3 is a block diagram of an example of a tag.

FIG. 4 is a flow diagram illustrating a process of identifying a tag by an RFID reader.

FIG. 5 is a block diagram of a command message according to an exemplary embodiment.

FIG. 6 is a diagram illustrating an example of a query tree in a general query tree protocol (QT).

FIG. 7 is a diagram illustrating a query tree in a reversed query tree protocol (QTR) according to an exemplary embodiment.

FIG. 8 is a graph illustrating the frequency of transmission of a query message in the query tree protocol (QT) and the frequency of transmission of a query message in the reversed query tree protocol (QTR).

FIG. 9 is a graph illustrating the number of bits transmitted in the query tree protocol (QT) and the number of bits transmitted in the reversed query tree protocol (QTR).

### BEST MODE

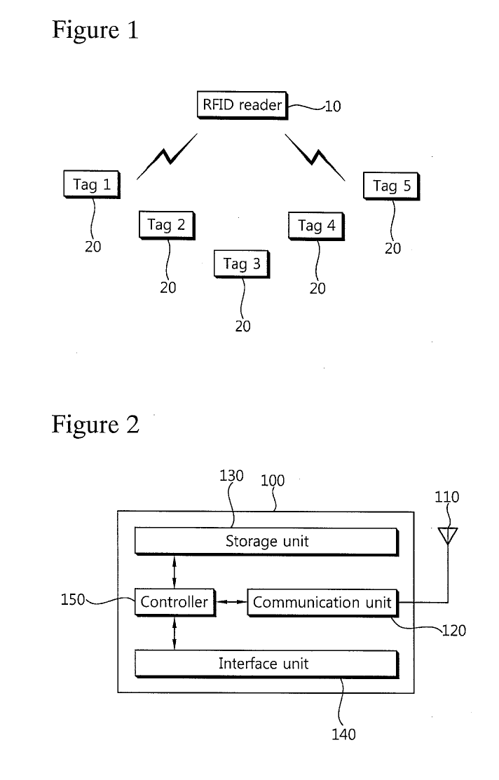

FIG. 1 is a block diagram of an example of a Radio Frequency IDentification (RFID) system.

Referring to FIG. 1, an RFID system includes an RFID reader 10 and one or more tags 20. There is no limitation on the number of tags 20.

The RFID reader 10 may also be called an interrogator, a tag identifying apparatus, or a tag detector. The RFID reader 10 communicates with the tag 20 in order to read information of the tag 20. The RFID reader 10 encodes data and transmits the same to the tag 20 over a radio channel. Also, the RFID reader 10 detects unique information of the tag 20 by decoding a signal received from the tag 20. The RFID reader 10 may be a stationary RFID reader or a mobile RFID reader.

The Tag 20 includes an Integrated Circuit (IC) chip and an antenna. The tag 20 has an identifier (ID) that is its unique information. The ID may be written in the format of a binary string. In general, a tag ID includes a plurality of fields. For example, an Electronic Product Code (EPC), which represents a unique identification number of a specific product of a provider, includes four fields of a header, a company ID, a product ID, and a serial number. The header defines the length and structure of the EPC; the company ID is defined as a unique number per company; and the product ID is given as a unique number according to the type of a company product. Thus, different serial numbers are given to respective products. That is, the tags 20 with different EPCs are attached to respective products so that the respective products can be discriminated from each other.

Upon receiving a query message from the RFID reader 10, the tag 20 transmits unique information or a value calculated from the unique information to the RFID reader 10 in response to the query message. The tag 20 may be an active tag with a battery or a passive tag without a battery.

A transmission link from the RFID reader 10 to the tag 20 is referred to as a forward link, and a transmission link from the tag 20 to the RFID reader 10 is referred to as a return link. The range of signal transmission from the RFID reader 10 through the forward link is limited, and the range of transmission from the tag 20 through the return link is limited. The RFID reader 10 can communicate data with the tag 20 that is located within the range of forward link and within the range of the return link. The range of data communication of the RFID reader 10 with the tag 20 is referred to as the readable range of the RFID reader 10.

FIG. 2 is a block diagram of an example of an RFID reader.

Referring to FIG. 2, an RFID reader 100 includes an antenna 110, a communication unit 120, a storage unit 130, an interface unit 140, and a controller 150.

The communication unit 120 includes an RF module (not illustrated) and a modem module (not illustrated), and communicates RF signals with tags. The RF module converts a data signal into an RF signal and transmits the RF signal through the antenna 110. Also, the RF module receives an RF signal from the antenna 110 and converts the RF signal into a data signal of a predetermined band. The modem module modulates data, which is to be transmitted to a tag, into a data signal. Also, the modem module demodulates a data signal, which is received from a tag, into data.

The storage unit 130 stores information necessary for identification of tags. For example, the storage unit 130 stores tag IDs received from tags, product information corresponding to the tag IDs, and various command messages.

The interface unit 140 includes specific interfaces and communicates data with an external system. The interface unit 140 may include a serial communication interface, a parallel communication interface, a USB interface, and an Ethernet interface.

The controller 150 controls the communication unit 120, the storage unit 130, and the interface unit 140. The controller 150 detects if there is a collision between signals received from tags, and performs various processes for resolving a collision between tags. In the tree-based protocol, the controller 150 generates and manages a tree. The controller 150 generates a string of a queue and transmits a query message carrying the string. The controller 150 may generate a tree in the reverse order of the strings (tag IDs) of tags. This will be described in detail later.

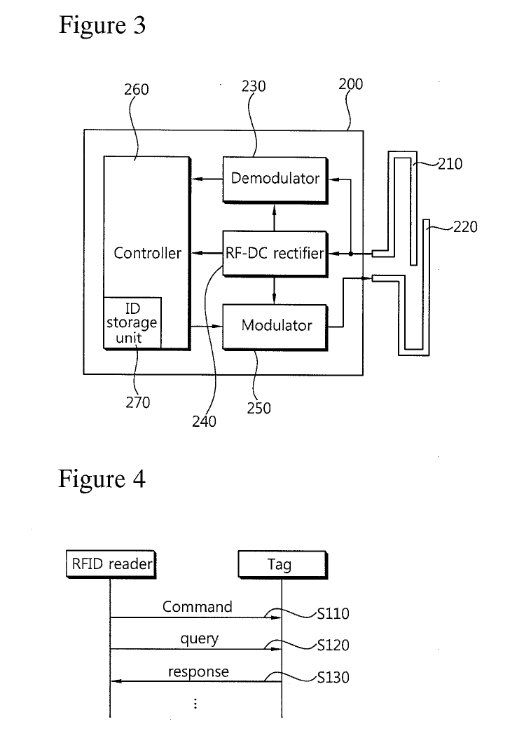

FIG. 3 is a block diagram of an example of a tag.

Referring to FIG. 3, a tag 200 includes a receiving antenna 210, a transmitting antenna 220, a demodulator 230, a Radio Frequency-Direct Current (RF-DC) rectifier 240, a modulator 250, a controller 260, and an ID storage unit 270.

The receiving antenna 210 receives an RF signal from an RFID reader and transfers the RF signal to the RF-DC rectifier 240. The RF-DC rectifier 240 generates power from the RF signal and supplies the power to the demodulator 230, the modulator 250, the controller 260, and the ID storage unit 270.

The demodulator 230 demodulates an RF signal received through the receiving antenna 210. The modulator 250 modulates data, which is to be transmitted to the RFID reader, into a data signal and transmits the data signal through the transmitting antenna 220 to the RFID reader.

The ID storage unit 270 stores a unique ID of the tag 200. The controller 260 generates a response signal according to a query message and a command message received from the RFID reader. The controller 260 may determine a response mode according to a command message received from the RFID reader. In the tree-based protocol, upon receiving a query message from the RFID reader, the controller 260 may generate and transmit a response message by comparing a tag ID stored in the ID storage unit 270 with a string contained in the query message. The controller 260 may compare the string contained in the query message with the tag ID in the reverse order. The controller 260 may generate a reversed ID and compare the same with the string contained the query message.

Hereinafter, a description will be given of the tree-based protocol between an RFID reader and a tag.

FIG. 4 is a flow diagram illustrating a process of identifying a tag by an RFID reader according to the tree-based protocol.

Referring to FIG. 4, an RFID reader transmits a command message to a tag in step S110. The command message is used to control the statuses of tags in order to prevent a collision between tags within the readable range of the RFID or a collision between a plurality of RFID readers. The command message contains control information about the response modes, the response times and the types of response messages to be transmitted by tags.

In step S120, the RFID reader transmits a query message to the tag. The query message is transmitted in broadcast mode to tags within the range of a forward link of the RFID reader. In the tree-based protocol, the RFID reader transmits a string with a size of 1 to several bits through a query message and retains a string, which is larger in size by 1 bit than the transmitted string, in a queue. An initial queue has a string of 0 and 1. The RFID reader identifies a plurality of tags by generating a tree with increasing the length of a string of a queue gradually. The tree generating method will be described later.

In step S130, the tag transmits a response message to the RFID reader in response to the query message. The tag may respond by generating 0 or 1 randomly and making a comparison with the query message, which is referred to as a binary tree protocol. The tag may respond by comparing its own ID with the query message, which is referred to as a query tree protocol.

Hereinafter, a description will be given of the characteristics of the query message in the query tree protocol.

The string contained in the query message may be the prefix of the tag ID (string). The prefix may have a size of 1 bit or n bits (n: an integer greater than 1), and occupies the head of the string (ID) owned by the tag. That is, the prefix may be the Most Significant Bit (MSB) or a string of the MSB to nth bit. The tag responds if the head of its own ID is equal to the prefix contained in the query message. For example, the tags with an ID of ‘01xxx’ respond if the prefix is ‘01’.

The string contained in the query message may be the suffix of the tag ID (string). The suffix may have a size of 1 bit or m bits (m: an integer greater than 1), and occupies the tail of the string (ID) owned by the tag. That is, the suffix may be the Least Significant Bit (LSB) or a string of the LSB to mth bit. The tag responds if the tail of its own ID is equal to the suffix contained in the query message. For example, the tags with an ID of ‘xxx01 ’ respond if the suffix is ‘01 ’. A method of generating a query tree by using a prefix is referred to as a general query tree protocol (QT), and a method of generating a query tree by using a suffix is referred to as a reversed query tree protocol (QTR).

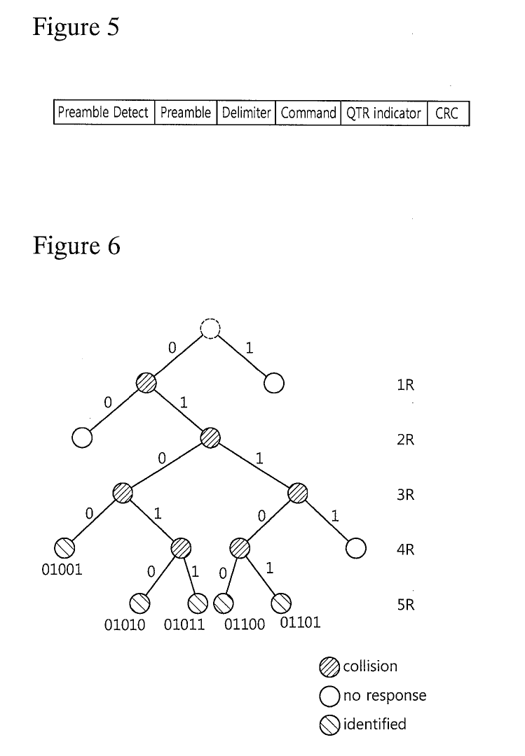

FIG. 5 is a block diagram of the command message according to an exemplary embodiment of the present invention.

Referring to FIG. 5, the command message includes a Preamble Detect field, a Preamble field, a Delimiter field, a Command field, a QTR Indicator field, and a Cyclic Redundancy Check (CRC) field.

The Preamble Detect field is used for preamble detection, and generally includes a predetermined carrier that is not modulated during 400 μm. The Preamble field is in a Non-Return to Zero (NRZ) format and may use a Manchester code. The NRZ is a format of encoding that converts a binary value ‘1’ and a binary value ‘0’ into a positive (+) voltage value and a negative (−) voltage value respectively. The Delimiter field may contain various delimiters to indicate the start of data.

The Command field carries control information about the response modes, the response times and the types of response messages to be transmitted by tags. The QTR Indicator field is used to indicate whether to execute the reversed query tree protocol (QTR). The reversed query tree protocol will be described in detail later. The QTR indicator field may use 1-bit data to indicate whether to execute the reversed query tree protocol. For example, if the value of the QTR Indicator field is ‘1’, the reversed query tree protocol is executed. In this case, the tag compares its own ID in reverse order to transmit a response message in response to the query message received from the RFID reader. If the value of the QTR Indicator field is ‘0’, not the reversed query tree protocol but the general query tree protocol is executed. In this case, the tag compares its own ID in order from the Most Significant Bit (MSB) to transmit a response message in response to the query message received from the RFID reader. The CRC field contains a cyclic binary code to detect an error in a data transmission process. The above arrangement of the respective fields is merely an example and is not intended to limit the scope of the present invention. The Delimiter field, the Command field, and the QTR Indicator field may interchange positions with each other.

Hereinafter, a description will be given of a method for generating a query tree in the query tree protocol (QT) to identify a tag.

FIG. 6 is a diagram illustrating an example of a query tree in the query tree protocol.

Referring to FIG. 6, it is assumed that five tags are located in the recognizable range of the RFID reader and the IDs of the respective tags are {01001, 01010, 01011, 01100, 01101}.

Table 1 below shows queries and responses during the period when all of the five tags are identified using the general query tree protocol (QT). A Round (R) is a period when the same length of strings for queries and responses are used, which means the length of a string or the depth of a tree. A Step means the frequency of queries and responses.

TABLE 1

| Round | Step | Query | Response |
|---|---|---|---|
| 1R | 1 | 0 | Collision |
| | 2 | 1 | No response |
| 2R | 3 | 00 | No response |
| | 4 | 01 | Collision |
| 3R | 5 | 010 | Collision |
| | 6 | 011 | Collision |
| 4R | 7 | 0100 | 01001 |
| | 8 | 0101 | Collision |
| | 9 | 0110 | Collision |
| | 10 | 0111 | No response |
| 5R | 11 | 01010 | 01010 |
| | 12 | 01011 | 01011 |
| | 13 | 01100 | 01100 |
| | 14 | 01101 | 01101 |

The RFID reader has 0 and 1 in an initial queue. The RFID reader retrieves strings from the queue as prefixes one by one to query tags.

1 Step: The RFID reader retrieves 0 from the queue to query tags. The tags compare the same with the Most Significant Bit (MSB) value of their own ID (string). The MSB is the first bit (from the left). Because the query of the RFID reader accords with their own MSB value, all of the five tags respond using their own ID. Because the first bit values of the responses of the tags accord but the other bit values do not accord, there occurs a collision that the RFID reader fails to identify the responses of the tags. In the event of the collision, the RFID reader suffixes 0 and 1 to the 0 to generate ‘00’ and ‘01’ in the queue.

2 Step: The RFID reader retrieves 1 from the queue to query tags. Because their own MSB value does not accord with the query, the tags do not respond (No response). In the event of no response, the RFID reader continues to query using the next string ready in the queue, without doing anything. The RFID reader uses both of the 0 and 1 of the initial queue to terminate 1 Round. In this case, the depth of the tree is 1.

3 Step: The RFID reader retrieves ‘00’ ready in the queue to query tags. The tags compare the values of the MSB to the second bit with the query of the RFID reader. Because their own MSB value does not accord with the query, the tags do not respond (No response).

4 Step: The RFID reader retrieves ‘01’ ready in the queue to query tags. All of the five tags respond and a collision occurs (Collision). The RFID reader suffixes 0 and 1 to the 01 to generate ‘010’ and ‘011’ in the queue. 2 Round is terminated and the depth of the tree is 2.

5 Step: The RFID reader queries tags about ‘010’ ready in the queue and receives responses from tags with ID={01001, 01010, 01011}, thus causing a collision (Collision). ‘0100’ and ‘0101’ are generated in the queue.

6 Step: The RFID reader queries tags about ‘011’ ready in the queue and receives responses from tags with ID={01100, 01101}, thus causing a collision (Collision). ‘0110’ and ‘0111’ are generated in the queue. 3 Round is terminated and the depth of the tree is 3.

7 Step: The RFID reader queries tags about ‘0100’ ready in the queue and receives a response from a tag with ID={01001} to identify the tag. After identification of the tag, the RFID reader continues to query using the next string ready in the queue.

In this way, the RFID reader has a string of 0 and 1 in the initial queue and transmits the prefix to tags. Thereafter, if a collision occurs, the RFID reader increases the length of a string by 1 bit to generate a new string in the queue. If there is no response from the tags or one tag is identified, the RFID reader continues to query using the next string in the queue. The RFID reader repeats a query until there is no string ready in the queue, thereby identifying all the tags.

Herein, until there is no string ready in the queue, that is, until all of the five tags are identified, the query and the response are performed 14 times and the depth of the tree is 5.

Hereinafter, a description will be given of a method for generating a query tree in the reversed query tree protocol (QTR) to identify a tag.

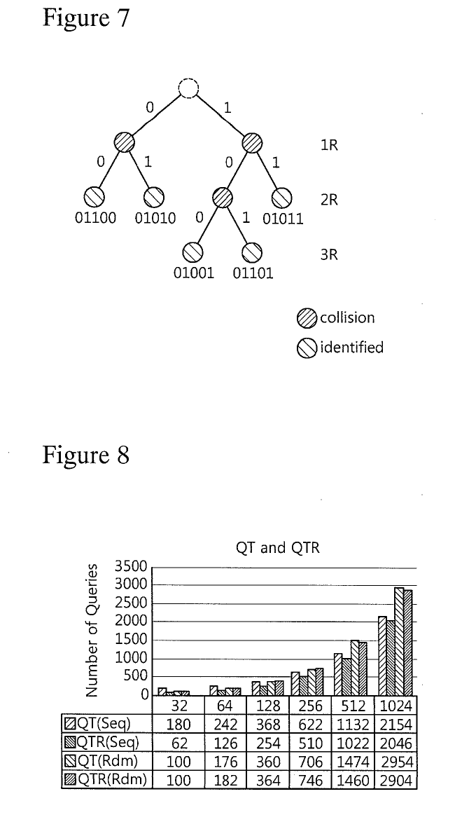

FIG. 7 is a diagram illustrating a query tree in the reversed query tree protocol according to an exemplary embodiment.

Referring to FIG. 7, it is assumed that five tags are located in the recognizable range of the RFID reader and the IDs of the respective tags are {01001, 01010, 01011, 01100, 01101}.

Table 2 below shows queries and responses during the period when all of the five tags are identified using the reversed query tree protocol (QTR). A Round (R) is a period when the same length of strings for queries and responses are used, which means the length of a string or the depth of a tree. A Step means the frequency of queries and responses.

TABLE 2

| Round | Step | Query | Response |
|---|---|---|---|
| 1R | 1 | 0 | Collision |
| | 2 | 1 | Collision |
| 2R | 3 | 00 | 01100 |
| | 4 | 01 | 01010 |
| | 5 | 10 | Collision |
| | 6 | 11 | 01011 |
| 3R | 7 | 100 | 01001 |
| | 8 | 101 | 01101 |

The RFID reader has 0 and 1 in an initial queue. The RFID reader retrieves strings from the queue as prefixes one by one to query tags. The tags compares their ID with the suffix of the RFID reader in reverse order. The tag compares a reversed ID with the suffix of the RFID reader. Reading the IDs of tags in order from the LSB to MSB is referred to as a reversed ID. The reversed IDs of the respective tags are {10010, 01010, 11010, 00110, 10110}. The tag compares the query (suffix) of the RFID reader with the reversed ID. If its own reversed ID accords with the suffix, the tag respond using its own ID.

Table 3 below shows an example of the algorithm of the reversed query tree protocol (QTR).

TABLE 3

```
  *** Reversed Query Tree Protocol : Reader Pseudo-code ***
  Q = {‘0’, ‘1’}
  while (Q is not empty) :
    suffix = pop a suffix from Q
    send QUERY command to tags with suffix
    reply = receive reply from tags
    if (reply is identified) :
      # a tag is identified
    else if (reply is collision) :
      append (suffix ‘0’) to Q
      append (suffix ‘1’) to Q
    end if
  end while
  *** Reversed Query Tree Protocol : Tag Pseudo-code ***
  suffix = receive suffix from reader
  if (reversed ID starts with suffix) :
    return ID
end if
```

The RFID reader has a string of 0 and 1 in the initial queue and transmits the suffix to tags. Thereafter, if a collision occurs, the RFID reader increases the length of a string by 1 bit to generate a new string in the queue. If there is no response from the tags or one tag is identified, the RFID reader continues to query using the next string in the queue. The RFID reader repeats a query until there is no string ready in the queue, thereby identifying all the tags.

According to the reversed query tree protocol (QTR),

1 Step: The RFID reader retrieves 0 from the queue to query tags. The tags compare the same with the MSB value of their own reversed ID. The MSB of the reversed ID corresponds to the LSB. The tags with ID={01100, 01010} (i.e., the MSB value of the reversed ID is 0) respond, thus causing a collision (Collision). The RFID reader suffixes 0 and 1 to the 0 to generate ‘00’ and ‘01’ in the queue.

2 Step: The RFID reader retrieves 1 from the queue to query tags. The tags with ID={01001, 01101, 01011} (i.e., the MSB value of the reversed ID is 1) respond, thus causing a collision (Collision). The RFID reader suffixes 0 and 1 to the 1 to generate ‘10’ and ‘11’ in the queue. Round 1 is terminated and the depth of the tree is 1.

3 Step: The RFID reader queries tags about ‘00’ ready in the queue and receives a response from a tag with ID={01100} (i.e., the MSB to second bit value of the reversed ID is 00) to identify the tag (identified).

4 Step: The RFID reader queries tags about ‘01’ ready in the queue and receives a response from a tag with ID={01010} (i.e., the MSB to second bit value of the reversed ID is 01) to identify the tag (identified).

5 Step: The RFID reader queries tags about ‘10’ ready in the queue and receives responses from tags with ID={01001, 01101} (i.e., the MSB to second bit value of the reversed ID is 10), causing a collision (Collision). The RFID reader suffixes 0 and 1 to the 10 to generate ‘100’ and ‘101’ in the queue.

6 Step: The RFID reader queries tags about ‘11’ ready in the queue and receives a response from a tag with ID={01011} (i.e., the MSB to second bit value of the reversed ID is 11) to identify the tag (identified). Round 2 is terminated and the depth of the tree is 2.

7 Step: The RFID reader queries tags about ‘100’ ready in the queue and receives a response from a tag with ID={01001} (i.e., the MSB to third bit value of the reversed ID is 100) to identify the tag (identified).

8 Step: The RFID reader queries tags about ‘101’ ready in the queue and receives a response from a tag with ID={01101} (i.e., the MSB to third bit value of the reversed ID is 101) to identify the tag (identified). Round 3 is terminated and the depth of the tree is 3. Because there is no string ready in the queue, the RFID reader terminates the tag identification process. Until all of the five tags are identified, the query and the response are performed 8 times.

In comparison with the general query tree protocol (QT), the reversed query tree protocol (QTR) is smaller in terms of the depth of the tree and the frequency of queries and responses. That is, using the reversed query tree protocol (QTR), the RFID reader can identify all the tags in its recognizable range within a shorter time. Also, because the tag identifies and responds to the query of the RFID reader in reverse order in the reversed query tree protocol (QTR) and the RFID reader can generate the query tree in the same way as in the general query tree protocol (QT), it is unnecessary to provide an additional processor in the RFID reader.

FIG. 8 is a graph illustrating the frequency of transmission of a query message in the query tree protocol (QT) and the frequency of transmission of a query message in the reversed query tree protocol (QTR).

Referring to FIG. 8, the number of queries depending on the number of tags in the cases of sequent tag IDs (Seq) and random tag IDs (Rdm) is shown. It can be seen from FIG. 8 that the reversed query tree protocol (QTR) can identify the tags more effectively because it is smaller than the query tree protocol (QT) in terms of the number of queries.

The number of queries in communication between the RFID reader and the tag will be described on the assumption that a plurality of tag IDs are sequent integers. Assume that A={b₀, b₁, . . . , bₙ₋₁} is a set of strings with the same length. Q(A) is defined as a query tree obtained by applying the query tree protocol to A. Q(A) is determined according to A. e(A) is the number of edges of Q(A), that is, the number of queries by the RFID reader. Equation (1) below expresses the number of queries by the RFID reader in the general query tree protocol (QT). Equation (2) below expresses the number of queries by the RFID reader in the reversed query tree protocol (QTR).

e(A)=2(H−h)+e(B) (1)

e(A^{R})=e(B^{R})=2(n−1) (2)

Herein, A^{R} denotes a reversed string obtained by reading a string of A in reverse order. B={d₀, d₁, dₙ₋₁}, and bᵢ=(0=i=n−1). cdᵢ is a string formed by suffixing dᵢ a string c. H denotes the length of a tag ID, h denotes the length of d₀, and n denotes the number of tag IDs. e(B^{R})=2(n−1) denotes the minimum number of queries for n tag IDs. Thus, e(B)=e(B^{R}) and e(A)=e(A^{R}). That is, the number of queries in the reversed query tree protocol (QTR) is smaller than the number of queries in the general query protocol (QT).

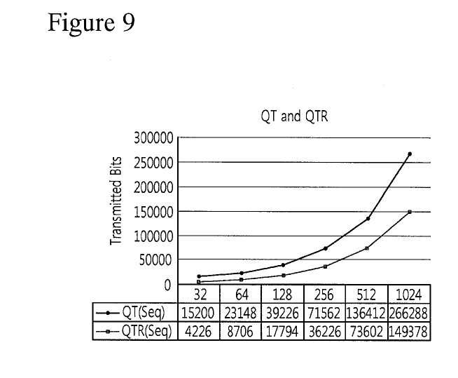

FIG. 9 is a graph illustrating the number of bits transmitted in the query tree protocol (QT) and the number of bits transmitted in the reversed query tree protocol (QTR).

Referring to FIG. 9, the number of queries depending on the number of tags in the case of sequent tag IDs (Seq) is shown. It can be seen from FIG. 8 that the reversed query tree protocol (QTR) can identify the tags more effectively because it is smaller than the query tree protocol (QT) in terms of the number of transmitted bits.

When the same company ID and the product ID occupy the head of a tag ID and a serial number is suffixed to the tail of the tag ID like an EPC code, the reversed query tree protocol can be used to efficiently identify the more tags using the less queries. The reversed query tree protocol can be efficiently used to manage products with tags of sequent IDs by a provider using many tags with similar IDs.

Although the case of the tag ID length being 5 bits has been described, it is merely an example and there is not limitation on the tag ID length. Although the tag ID has been represented by a binary number, the present invention is not limited thereto. That is, the reversed query tree protocol can be similarly applied even when the tag ID is represented in different ways.

As described above, the present invention generates the query tree in the reverse order of the tag IDs in the query tree-based protocol to reduce the frequency of collisions between the tags, thereby making it possible to reduce the time taken to identify all the tags within the recognizable range of the RFID reader.

While the present invention has been particularly shown and described with reference to exemplary embodiments thereof, it will be understood by those of ordinary skill in the art that various changes in form and details may be made therein without departing from the spirit and scope of the present invention as defined by the following claims. Therefore, future modifications to the embodiments of the present invention cannot depart from the technical scope of the present invention.

1. A tag identification method for generating a query tree according to a query and a response between an RFID reader and a tag to identify the tag, the tag identification method comprising:
transmitting a query message from the RFID reader to the tag; and
receiving a response message for the query message from the tag,
wherein the query tree is generated in the reverse order of a string owned by the tag.

2. The tag identification method of claim 1, wherein the query message is a suffix of the string.

3. The tag identification method of claim 2, wherein if there is a collision between the response message and a response message from another tag, the RFID reader generates a string, which is obtained by attaching an additional character to the suffix, in a queue.

4. The tag identification method of claim 1, wherein the tag compares the query message with the string in the order of from the least significant bit to the most significant bit of the string to transmit the response message.

5. The tag identification method of claim 1, wherein the tag generates a reversed ID for the ID of the tag to make a comparison with the query message.

6. A tag anti-collision method comprising:
receiving a first suffix from an RFID reader;
transmitting a first response message after comparison of the first suffix with a tag ID in reverse order;
receiving a second suffix longer than the first suffix after transmission of the first response message; and
transmitting a second response message after comparison of the second suffix with the tag ID in reverse order.

7. The tag anti-collision method of claim 6, wherein the first suffix is a string of the least significant bit (LSB) to the m^{th} bit of the tag ID; the second suffix is a string of the least significant bit (LSB) to the n^{th} bit of the tag ID; ‘n’ is greater than ‘m’; and ‘n’ and ‘m’ are integers greater than 0.

8. An RFID tag comprising:
a demodulator unit demodulating a query message received from an RFID reader;
a controller unit comparing a string contained in the query message with a tag ID in reverse order and generating a response message if the string is equal to the tag ID; and
a modulator unit modulating the response message prior to transmission.

9. The RFID tag of claim 8, wherein the response message is the tag ID.
